(19) United States
(12) Patent Application Publication
(10) Pub. No.: US 2007/0061209 A1
(43) Pub. Date: Mar. 15, 2007

(54) Restaurant electronic menu, ordering and payment system and method

(76) Inventor: Roland Wade Jackson, Lewisville, TX (US)

Correspondence Address: Galasso & Associates, LP, P.O. Box 26503, Austin, TX, 78755-0503, US

(21) Appl. No.: 11/507,840

(22) Filed: Aug. 22, 2006

Related U.S. Application Data
(60) Provisional application No. 60/715,435, filed on Sep. 9, 2005.

(51) Int. Cl. G06Q 30/00

(52) U.S. Cl. 705/15

(57) ABSTRACT

The restaurant electronic menu, ordering and payment devices and the order processing computer system allows restaurant patrons to review the menu, select food and beverages from the menu and electronically place their orders even before a seating in the restaurant is available. The system provides food and beverage orders to the kitchen staff well ahead of the convention order placing systems and permits patrons to review, print and pay their guest check electronically from their restaurant table, at will, without waiting for service or depending upon the responsiveness and staff levels of the restaurant, thereby providing the best possible service in the shortest possible time and eliminating bottlenecks and headaches of the conventional restaurant order and payment systems.

### CROSS REFERENCE TO RELATED APPLICATIONS

This application claims priority to co-pending U.S. Provisional Patent Application having Ser. No. 60/715,435 filed Sep. 9, 2005, entitled “Why Wait Waiter”, having a common applicant herewith.

### FIELD OF THE DISCLOSURE

The disclosures made herein relate generally to restaurant order handling and payment handling systems and, more particularly, to an electronic menu, ordering and payment device that is small in size and assignable and trackable to a single guest or group of guests when they enter the restaurant. The device is configured and adapted to provide the restaurant food and beverage menu electronically to the guests or patrons, wherein the patrons can order menu items directly by interacting with the touch screen on the device as well as pay for food and beverage purchases directly by use of the device.

### BACKGROUND

Many varieties of electronic and ordering systems facilitating menu food orders at restaurants are known. One common variety is a system used in certain drive-in restaurants wherein a patron parks their car near an apparatus which displays a menu of available fare, the patron reads the menu from the car and then orders the food and beverage items by interacting verbally with a restaurant employee through a loud speaker and microphone contained within the menu display apparatus.

Another type of electronic food and beverage ordering system is the type used in certain automat type dining facilities, wherein the food is stored and displayed in vending machines and the patron selects the food to vend, deposits money into the vending machine, pushes a button on the vending machine causing the machine to vend the selected food items.

Restaurants are known to have various order processing systems wherein an order taker receives the patron's food order and enters the food selections on an electronic cash register or other order entry apparatus. The order entry apparatus communicates with an order processing system that displays the patron's order to the restaurant's kitchen staff, wherein the kitchen staff works serially and diligently through the displayed orders to complete each order and deliver the prepared food items to the patrons. Such systems have one or more limitations, however, one being that the patron must wait in line to provide their food and beverage order to an order taker rather than just placing the order themselves. Another limitation of such systems is that the patron many times must stand waiting their turn to place the food order rather than proceeding immediately to find a table and relax in the seats of the table.

Another highly conventional restaurant order taking system is known. In this system the patrons provide their names to a greeter near the door. The greeter places their name on the waiting list. After enough time passes that the patrons are ‘next in line’, the greeter calls the patron's name. The patrons identify themselves to the greeter, then follow the greeter to a table in the restaurant and are seated. The patrons then wait for menus to be delivered by restaurant wait staff. When the menus are delivered, the patrons review the menus to select food and beverage items and then wait for the wait staff to return to take their order. When the wait staff returns, the patrons give their food and beverage orders to the wait staff, which at some time afterwards is submitted to the kitchen for preparation. After the food is prepared, delivered, consumed and the meal is over, the patrons wait for the wait staff to return and they request their guest check. The patrons wait while the wait staff disappear and eventually prepare the patron's guest check or bill. When the bill eventually arrives, the patrons either take the check to the cash register and pay the bill or wait for the wait staff to return and pick up the bill with the payment. If the payment is by credit card, then the patrons must wait while the wait staff leaves the table with the guest check and credit card and runs the guest check amount through the credit card system for approval through an agency. When the credit card transaction is approved, the wait staff returns to the patron's table and provides the credit card receipt and requests a signature. The patron signs the credit card receipt, hands the signed receipt to the wait staff, and the patron is then free to leave the restaurant. There are a number of drawbacks in this conventional method of order placement and payment system, one being the time that is wasted while waiting to be seated, the time wasted while waiting for menus, the time wasted while waiting for the wait staff to return to take the food and beverage order, the time wasted while waiting for the wait staff to return with the guest check or bill, the time wasted while waiting for the wait staff to run a credit or debit card payment through the credit card approval system, the time wasted while waiting for the wait staff to return to the table with credit card receipt ready for signature.

Therefore, a restaurant electronic menu, ordering and payment device and system which allows restaurant patrons to review the menu, select food and beverages from the menu and electronically place their orders even before a seat is available, a device and system that provides food and beverage orders to the kitchen staff well ahead of the conventional order placing systems discussed above, a restaurant electronic menu, ordering and payment system and device that provides facilities for a patron to review, print and pay their guest check electronically from their restaurant table, at will, without waiting for service or depending upon the responsiveness and staff levels of the restaurant, a system and device that provides the best possible service in the shortest possible time and eliminates bottlenecks and headaches of the conventional systems discussed above, such a restaurant electronic menu, ordering and payment device and system would be useful and novel.

### SUMMARY OF THE DISCLOSURE

Accordingly, embodiments of the inventive disclosures made herein comprise a restaurant electronic menu, ordering and payment system and a method of using same.

In a first embodiment a restaurant electronic menu, ordering and payment system comprises a computer based system for processing of customer food and beverage orders, routing orders to kitchen, bar and wait staff, and accepting patron's credit card payment, the computer based system comprises a computer based order processing system. The order system comprises a microprocessor based logic system, an operating system executing on the microprocessor based logic system, one or more applications configured and adapted for execution upon the microprocessor based logic system under the operating system, a means of data communication between the order processing system and one or more restaurant electronic menu, ordering and payment devices, as well as provided within the restaurant one or more display stations for display of electronic patron food and beverage orders to restaurant staff. The one or more monitors are interfaced with and display information from the order processing computer system described above. At least a portion of the display stations are positioned to be easily viewable and accessible by restaurant staff near food and beverage work stations, such as the kitchen area, the beverage area, and by the bartender in the bar (if the restaurant is equipped with a bar). The order system includes an interface means to interface the above display stations to the computer based order processing system. The computer based order processing system further includes a means of interfacing an electronic cash register to the system, particularly for patrons who prefer to pay by cash or check rather than to use the self service credit card payment features of the system. The computer based order processing system further includes a means of interfacing restaurant accounting and inventory systems to the order processing system, to permit accounting and inventory systems access to the transaction trail of menu items sold, and sales volume. The order processing system accepts patron food and beverage orders, routes orders to food preparation and wait staff by display to the display stations in the kitchen and other work areas, presents electronic guest checks to patrons, accepts patron credit card payment of guest checks, tallies restaurant sales and menu items ordered to a data store for retrieval and printing, either manually or automatically.

The restaurant electronic menu, ordering and payment system also comprises one or more restaurant electronic menu, ordering and payment devices. These devices are compact in size and are easily carried by patrons or placed upon tables within the restaurant. These devices are operable in a plurality of areas within and about the restaurant, particularly in waiting areas and in the dining area. The devices provide electronic food ordering and bill payment functions to restaurant customers or patrons. The devices comprise a housing having a slot for a printed paper receipt to be delivered through from an internal printer, electronic computer based logic board secured within the housing, an attention light secured to an outside surface of the housing and interfaced to the logic board, a receipt printer secured within the housing for printing guest checks and credit card payment receipts to customers, a card swipe reader for reading a credit card for payment of the guest check, the card swipe reader secured to the housing and interfaced to the logic board, a means of data communication between the device and a restaurant order and payment system discussed above. The electronic menu, ordering and payment device further comprises a menu driven backlit graphic display screen secured to the top surface of the housing. The graphic display screen is equipped with touch input capabilities where, for example, patrons use screen touch input to select menus for display or to place orders for displayed items on the menu. The touch input capabilities are also used to navigate through device menus (as opposed to restaurant food menus) to order food and beverage items from the displayed restaurant menu, to specify food preparation options, for example well done or no onions, to summon wait staff to the table, and to receive an electronic guest check, among other functions. The graphic display screen is adapted to display advertisements and other announcements when the device is not being used to select food/beverage items or to review and pay guest checks.

In a second embodiment, the restaurant electronic menu, ordering and payment system of the first embodiment has a data communication means comprising a wireless network. The restaurant electronic menu, ordering and payment devices are in cooperative communication with the order processing system over this wireless network.

In a third embodiment, the restaurant electronic menu, ordering and payment system of the first embodiment has a data communication means comprising a physical data link such as a high speed serial or optical link. The restaurant electronic menu, ordering and payment devices are in cooperative communication with the order processing system over this physical link.

In a fourth embodiment a method of providing electronic food and beverage ordering and payment to patrons of a restaurant comprises providing a computer based order processing system having one or more display stations viewable and accessible by restaurant cook and wait staff. Electronic menu, ordering and payment devices are provided to patrons of the restaurant for their use while waiting to be seated and during dining. The devices are distributed among or readily accessible by patrons of the restaurant. Each device is equipped with a graphic display having touch input capabilities. The devices also include a built in credit/debit card reader and a printer for printing receipts such as credit card payment receipts as well as for printing guest checks and order summaries, particularly for business people who need to retain such receipts for expense reports or deduction of business expenses on tax returns. Each device further includes an attention light secured to the device. The electronic menu, ordering and payment devices are in cooperative data communication with the computer based order processing system discussed earlier. The method of use further comprises assigning an electronic menu, ordering and payment devices to patrons for their use as they enter the restaurant. The patrons then browse the restaurant specials and food beverage menu through the touch sensitive graphic display screen of the device. The patrons select one or more menu items to order on the device from the food and beverage items displayed on the device and order the items through the touch sensitive screen of the device. If an alcoholic beverage is selected for order, then the device prompts the patron to confirm that they are of legal drinking age (21 years old in most states). Food and beverage orders are then transmitted to the order processing system where the order is routed to and displayed upon workstation monitors in the kitchen, bar and other restaurant staff work areas as appropriate so that the wait staff may prepare and assemble the order and deliver it to the restaurant patrons.

In a fifth embodiment of a method of providing electronic food and beverage ordering and payment to patrons of a restaurant the fourth embodiment further comprises the following steps executable at any time after placing the food/beverage order. The electronic menu, ordering and payment device displays a summary of the current charges and provides a touch activated menu of payment options to restaurant patron on the graphic display screen of the electronic menu, ordering and payment device. The displayed payment option includes payment by credit/debit card as well as an option to pay at the cash registers or pay the waiter or server directly. If patron selects the option to pay by credit/debit card, then the device prompts the patron to swipe the credit card in the card reader of the device. Once the credit card is read by the device, then the device transmits credit card information to the order processing computer system wherein the credit card payment is checked with an agency to obtain approval for the credit charges. If the agency approves the charges, then the device closes out the guest check and prints a credit card on its internal printer and expels the receipt through a slot for the patron. If the agency declined the credit card payment authorization, then the device warns the user on the graphic screen that the payment is declined and to please pay at register or pay a server. The restaurant patron surrenders the electronic menu, ordering and payment device before leaving the restaurant.

In a sixth embodiment of a method of providing electronic food and beverage ordering and payment to patrons of a restaurant extends the method of the fifth embodiment by providing a menu selectable means of querying the order processing system on the status of a restaurant order from the electronic menu, ordering and payment device.

In a seventh embodiment of a method of providing electronic food and beverage ordering and payment to patrons of a restaurant further comprises a menu selectable means of summoning restaurant wait staff to the customer's table wherein if the patron selects to summon wait staff then the device transmits a wait staff needed message to the order processing system and then activates the attention light on the electronic menu ordering and payment device.

It is an objective of the inventive disclosure made herein to provide a restaurant electronic menu, ordering and payment device and system which allows restaurant patrons to review the menu, select food and beverages from the menu and electronically place their orders even before a seat is available.

It is another objective of the inventive disclosure made herein to provide a restaurant electronic menu, ordering and payment device and system that provides food and beverage orders to the kitchen staff well ahead of the conventional order placing systems discussed above.

It is another objective of the inventive disclosure made herein to provide a restaurant electronic menu, ordering and payment device and system that provides facilities for a patron to review, print and pay their guest check electronically from their restaurant table at will, without waiting for service or depending upon the responsiveness and staff levels of the restaurant.

It is another objective of the inventive disclosure made herein to provide a restaurant electronic menu, ordering and payment device and system that provides the best possible service in the shortest possible time and eliminates bottlenecks and headaches of the conventional systems as discussed in the background of the invention.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of a restaurant electronic menu, ordering and payment device in accordance with the inventive disclosures herein.

FIG. 2 depicts a top view of one embodiment of the restaurant electronic menu, ordering and payment device of FIG. 1 in accordance with the inventive disclosures herein.

FIG. 3 depicts a side view of one embodiment of the restaurant electronic menu, ordering and payment device of FIG. 1 in accordance with the inventive disclosures herein.

FIG. 4 depicts a high level flow diagram of a method of distributing and using the electronic menu, ordering and payment device in a restaurant in accordance with the inventive disclosures herein.

FIG. 5 depicts an exemplary top level menu having touch actuated menu selections for the electronic menu, ordering and payment device in accordance with the inventive disclosures herein.

FIG. 6 depicts a flow diagram of a process of using the electronic menu, ordering and payment device in a restaurant to view restaurant menu food and beverage selections and to order food and beverage items in accordance with the inventive disclosures herein.

FIG. 7 depicts a flow diagram of a process of using the electronic menu, ordering and payment device in a restaurant to pay a guest check using a credit or debit card directly from the device.

FIG. 8 depicts a flow diagram of a process of using the electronic menu, ordering and payment device in a restaurant to check the status of a food/beverage order.

FIG. 9 depicts a block diagram of a restaurant electronic menu, ordering and payment system showing major components and their inter-relationships.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

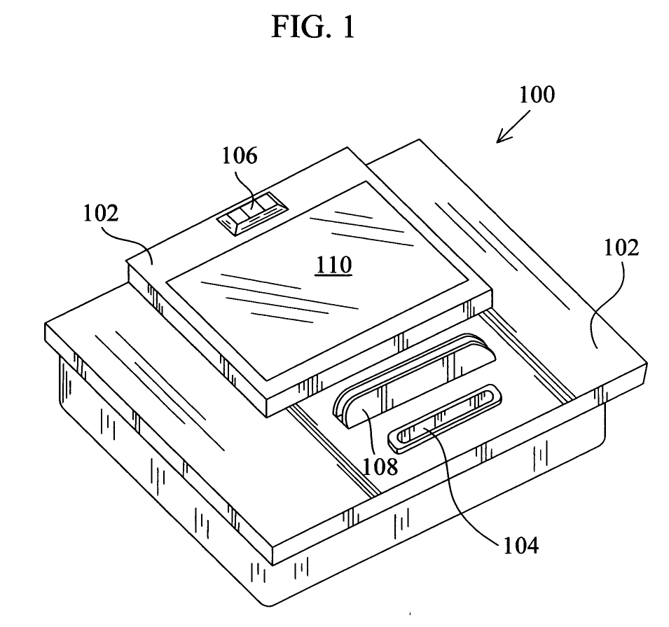

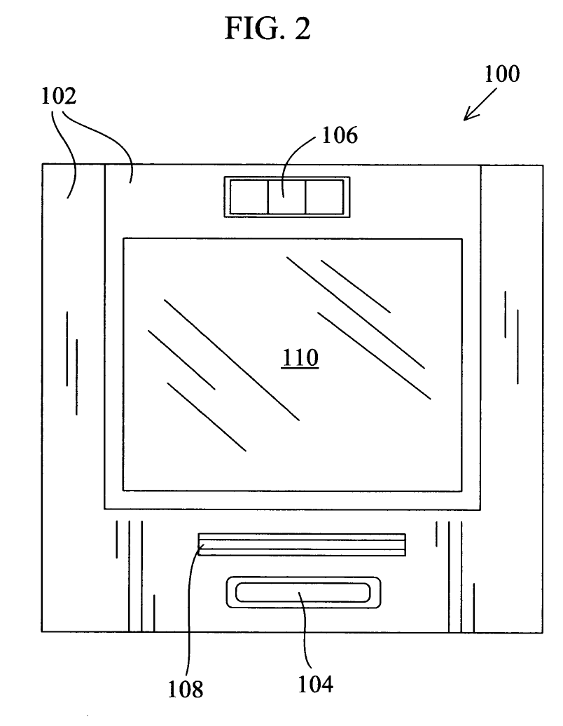

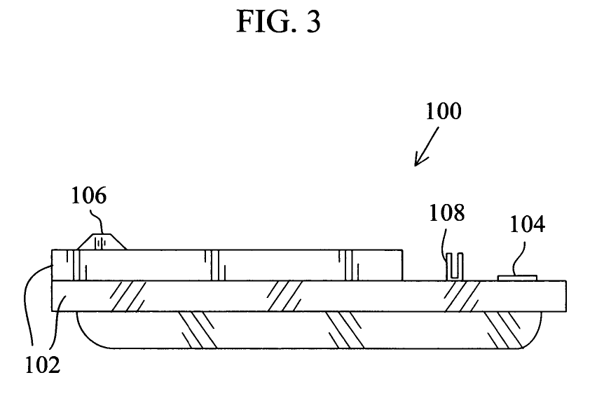

Turning now to FIG. 1, FIG. 2 and FIG. 3:

FIG. 1 depicts a perspective view of one embodiment of a restaurant electronic menu, ordering and payment device in accordance with the inventive disclosures herein. FIG. 2 depicts a top view of one embodiment of the restaurant electronic menu, ordering and payment device of FIG. 1 in accordance with the inventive disclosures herein. FIG. 3 depicts a side view of one embodiment of the restaurant electronic menu, ordering and payment device of FIG. 1 in accordance with the inventive disclosures herein. A restaurant electronic menu, ordering and payment device 100 comprises a housing 102 having a slot 104 for a printed paper receipt to be delivered through to the restaurant customer. Included within the housing of the device is an electronic computer based logic board (not shown). An attention light 106 is secured to the top portion of the device housing. The attention light 106 is interfaced to the electronic logic board of the device. The attention light illuminates under control of the electronic logic board and may be used as a means of calling attention to the table in the restaurant, for example, when a guest uses the device to summon help from a server or other restaurant wait staff. A receipt printer (not shown) is secured within the housing of the device and interfaced to the electronic logic board. The printer is for printing guest checks and credit card payment receipts for restaurant patrons or guests. The printed receipts are delivered to the customer through slot 104. The electronic menu, ordering and payment device 100 further comprises a card swipe reader 108 for reading a credit card or debit card for payment of the guest check at the patron's table directly through the device 100. The card swipe reader 108 is secured to a top portion of the device housing 102 and interfaced to the electronic logic board. A means of data communication between the device and a restaurant order and payment system is integrated within the housing of the device. The means may include electronics for wireless networking between the one or more electronic menu, ordering and payment devices and the order processing computer (described later). The means of data communication utilizes a wireless network compliant with the 802.11 networking standards as commonly employed in wireless computer networking. The means of data communication may alternately be a hard wired means wherein each restaurant electronic menu, ordering and payment device is equipped with a 10Base-T or 100 Base-T network port and accepts a CAT 5 cable connection to a network hub or router. Alternately still the means of data communication may utilize a fiber channel connection over a detachable fiber optic cable using conventional HSSB (high speed serial bus) communication over a fiber optic cable. In the preferred embodiment the restaurant electronic menu, ordering and payment device utilizes wireless networking following the 802.11 networking standards over a 2.4 GHz band and compatible with conventional wireless networking routers and hubs. The electronic menu, ordering and payment device includes a menu driven backlit graphic display screen 110 secured to the top surface of the housing 102, the graphic display screen 110 having touch input capabilities, wherein patrons use screen touch input to select menus for display, to page forward and backward through menus, to order food and beverage items from the restaurant menu and to specify food preparation options such as ‘well done’ or ‘no onions’. The touch input screen with touch selectable menu options may additionally be used to summon wait staff to the table and to receive an electronic guest check. When the device is ‘idle’ and not in use for food/beverage orders or other functions, the display screen of the device may display advertisements and other announcements as provided by the order processing computer.

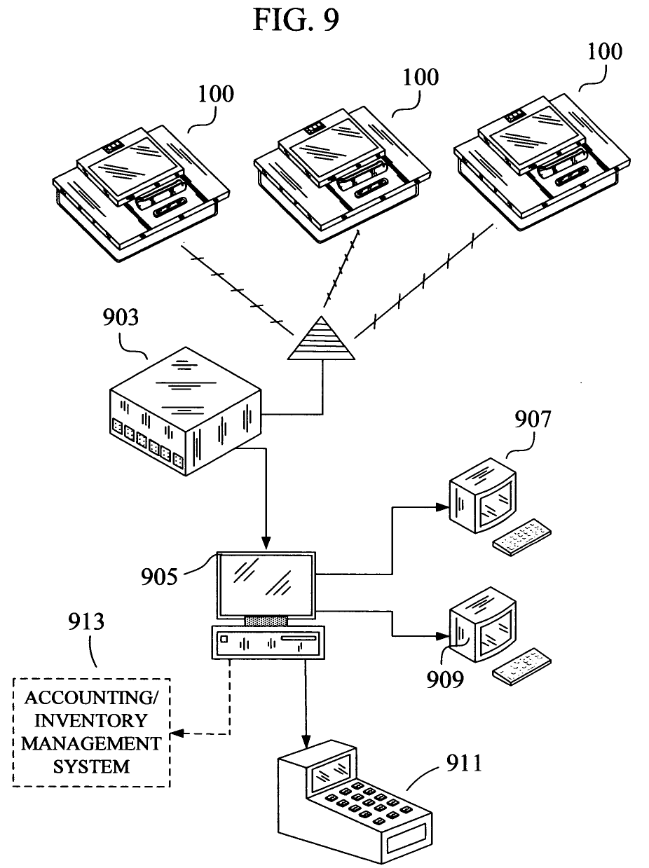

Turning now to FIG. 9:

FIG. 9 depicts a block diagram of a restaurant electronic menu, ordering and payment system showing major components and their inter-relationships. A plurality of electronic menu, ordering and payment devices 100 are provided to and in use by restaurant customers or patrons within or around the restaurant. The devices 100 are in wireless communication with a wireless hub 903 (such as a conventional 802.11 standard compliant wireless hub as used in computer networking). Computer based order processing computer 905 is in cooperative communication with the electronic menu, ordering and payment devices 100 through the wireless network. The order processing computer is a conventional desktop computer or server having a microprocessor base logic system, an operating system executing on the microprocessor based logic system and one or more applications configured and adapted for execution upon the microprocessor based logic system under the operating system to provide the customer order entry, routing of orders to display stations, support credit card payments of orders from the electronic menu, ordering and payment devices 100, track menu items sold for inventory tracking, and accumulation of sales volume information for later transfer to the restaurant's accounting and inventory management systems, if the restaurant utilizes such systems. The order processing computer 905 routes received customer food and beverage orders to display stations in the restaurant, such as one or more kitchen area display stations 907, one or more bar display stations 909, among others. The display stations may consist of ‘dumb’ ANSI or text type terminals with keyboards, the terminals interfaced to the order processing computer via serial communications cables. Alternately the display stations may comprise conventional desktop or notebook computers communicating with the order processing computer over the wireless network and wireless router 903. The display stations are positioned for viewing and use by restaurant staff near food and beverage work areas in the restaurant. The order processing computer includes an interface means to interface the one or more display stations to the computer based order processing system; which as discussed above may be serial communications to low cost ‘dumb’ text terminals over RS232, RS422, HSSB or fiber serial data connections. The order processing computer includes a means of interfacing an electronic cash register 911 with the order processing computer 905 to register and record patron check payments paid at the cash register. The order processing system accepts patron food and beverage orders, routes orders to food preparation and wait staff, presents electronic guest checks to patrons, accepts patron credit card payment of guest checks, tallies restaurant sales and menu items ordered to a data store for retrieval by external accounting and inventory management systems 913.

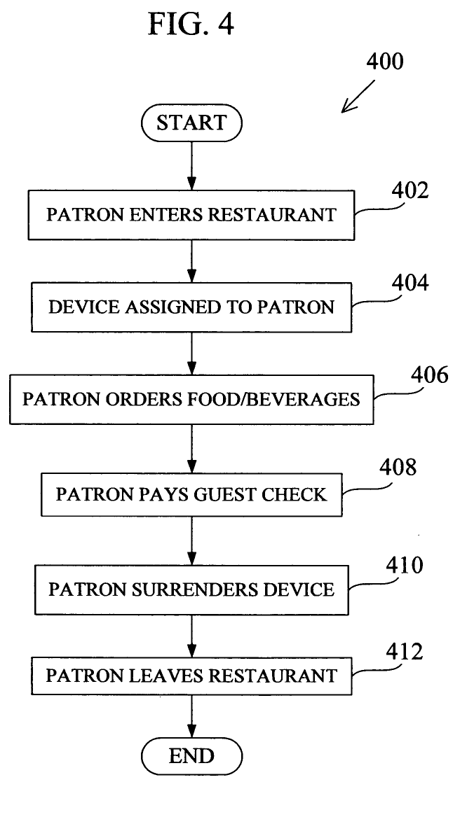

FIG. 4 depicts a high level flow diagram of a method 400 of distributing and using the electronic menu, ordering and payment device in a restaurant in accordance with the inventive disclosures herein. The method starts when the patron enters the restaurant at block 402. Sometime after entering the restaurant an electronic menu, ordering and payment device 100 is assigned and registered to the patron (single customer of a group of customers) at block 404. Registering the device 100 to the patron relates any orders placed through the device 100 to the patron and eventually to the table at which they are eventually seated. Each device 100 has a unique ID and orders placed through the device are tracked and traced to patrons and or table within the restaurant for billing, food preparation and food delivery by restaurant wait staff. The patron or group is either then seated or waits for the availability of a table to be seated. At block 406, while waiting to be seated or while seated the patron or their group may review the restaurants fare of food and beverages and, if desired, make order selections directly through the device 100 by making touch screen selections of food and beverage items desired from the restaurant menu displayed on the graphics screen of device 100. At block 408, some time after ordering the food/beverages the patron may review the accumulated guest check and pay the check using a credit card or debit card directly from the electronic menu, ordering and payment device 100. The device 100 is equipped with a credit card/debit card swipe reader 108. The patron reviews the guest check, then makes a touch selection to pay the bill by credit card, swipes the credit card through the card reader 108. The credit card information is transmitted by the device 100 to the order processing computer 905 for authorization. When the authorization is received, the transaction completes. At block 410, some time later before leaving the restaurant the patron surrenders the device 100 to the restaurant or an employee of the restaurant. The patron or group is then free to leave the restaurant at block 412.

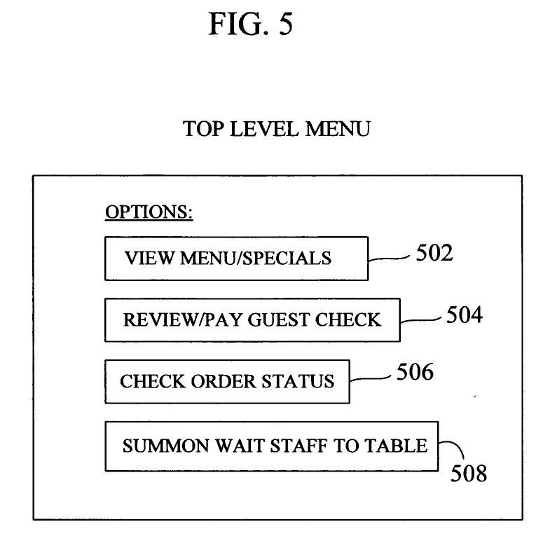

FIG. 5 depicts an exemplary top level menu having touch actuated menu selections for the electronic menu, ordering and payment device in accordance with the inventive disclosures herein. The top level menu is a menu providing access to lower level menus and functions available through the electronic menu, ordering and payment device 100. Menu selections 502, 504, 506 and 508 are selectable by the user touching the desired selection on the screen. Touch screens and touch screen input methods and technology are well known. Touch a high level menu selection such as 502 to view restaurant food/beverage menu and specials, bringing up lower level touch sensitive menus such as menus containing food and beverage fare selections with price and other information, as well as page forward and backwards touch selections for navigating the menu system. The top level menu illustrated is merely for enablement and better understanding of the invention. The invention is not limited to the use of the top level menu illustrated and may utilize additional menus and menu options.

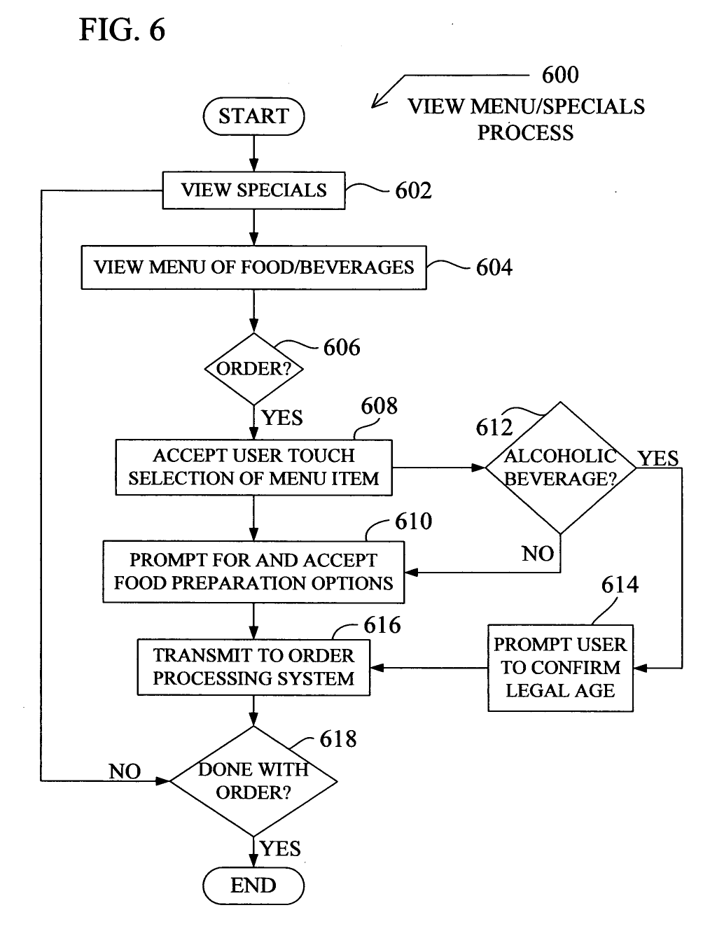

FIG. 6 depicts a flow diagram of a process 600 of using the electronic menu, ordering and payment device in a restaurant to view restaurant menu food and beverage selections and to order food and beverage items in accordance with the inventive disclosures herein. The patron accesses the restaurant food and beverage menu through a top level menu as discussed earlier. At block 602 the patron reviews the house specials on the electronic menu, ordering and payment device and at block 604 reviews the restaurant food and beverage offerings. While reviewing offerings the patron or patrons may order items from the food and beverage menus at block 602 and 604 by using the touch input capabilities of the graphic display screen of the device. At block 606, if items are selected for order, then at 608 the device accepts the patron's order, including asking for confirmation of the order. If an alcoholic beverage was ordered, then at block 612 transfers control to block 614 where the patron is prompted to confirm that they are of legal drinking age. At block 610 prompts the patron for whatever food preparation options may exist for the item or items selected. At block 616 the ordered items and preparation options are transmitted to the order processing computer for routing to display workstations in the restaurant, preparation by restaurant staff and delivery to the restaurant patrons. The order processing computer accumulates ordered items and charges on a guest check which is associated with the device and the patrons using the device. At block 618, if the patrons are not done with their order at this time, then control transfers back to display the specials and food/beverage menus of block 602 and 604, otherwise the process exits to the top level menu, one exemplary sample of which is shown in FIG. 5.

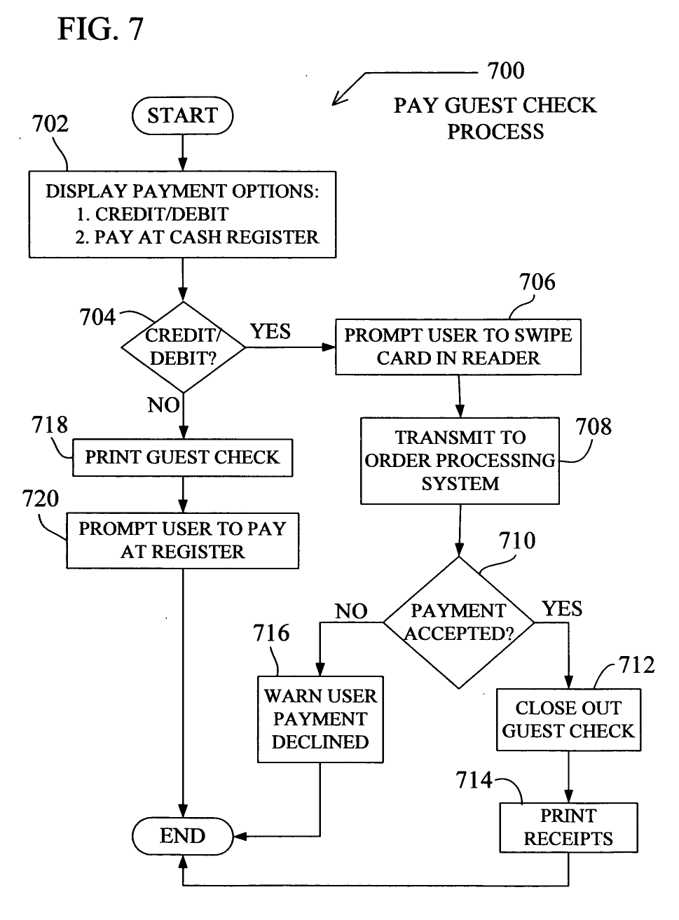

FIG. 7 depicts a flow diagram 700 of a process of using the electronic menu, ordering and payment device in a restaurant to pay a guest check using a credit or debit card directly from the device. At block 702 the patron is presented with a display of the guest check on the graphics display of the device. After reviewing the guest check the patron has the option of payment by credit/debit card directly through the electronic menu, ordering and payment device or the option of paying at the cash register (which may include another option, namely that of paying the server directly). Decision block 704 test if credit/debit payment was selected. If credit/debit payment then at block 706 the patron is prompted to swipe their credit card though the card reader built into the electronic menu, ordering and payment device. At block 708 the credit card information is transmitted to the order processing computer system which acts to process the charge against the patron's credit card. If the payment was approved at block 710, then the order processing computer system closes out the guest check tab 712 and instructs the electronic menu, ordering and payment device to print the receipts at block 714. If the credit card payment was denied, the order processing computer system sends a payment denied message to the electronic menu, ordering and payment device at block 716, where the message instructs the patron that the payment was denied and to please pay the server or pay at the cash register.

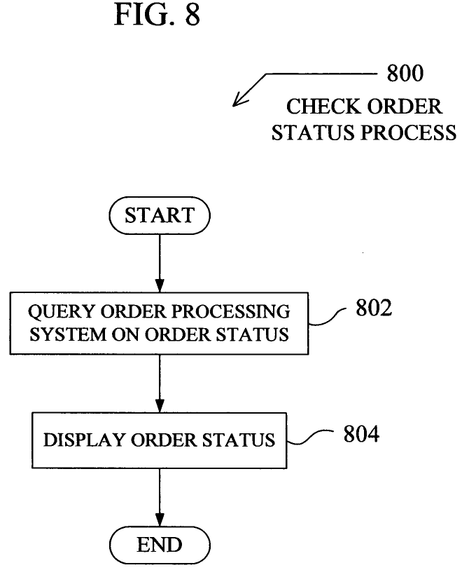

FIG. 8 depicts a flow diagram 800 of a process of using the electronic menu, ordering and payment device in a restaurant to check the status of a food/beverage order. Check order status is reached through a top level menu such as the exemplary top level menu depicted in FIG. 5. Once selected, at block 802 then the electronic menu, ordering and payment device transmits a query to the order processing computer for the status of food/beverage orders placed through the device. Order processing computer system responds at block 804 with status, wherein the status may include the expected time of delivery to the table.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A restaurant electronic menu, ordering and payment system, comprising:
a computer based system for processing of customer food and beverage orders, routing orders to kitchen, bar and wait staff, and accepting patron's credit card payment for payment, the computer based system comprising:
a microprocessor based logic system;
an operating system executing on the microprocessor based logic system;
one or more applications configured and adapted for execution upon the microprocessor based logic system under the operating system;
a means of data communication between the order processing system and one or more restaurant electronic menu, ordering and payment devices;
one or more display stations for display of electronic patron food and beverage orders, the one or more monitors interfaced with and display information from the order processing computer system, wherein a portion of the stations are positioned for viewing and use by restaurant staff near food and beverage work areas in the restaurant;
an interface means to interface the one or more display stations to the computer based order processing system;
a means of interfacing an electronic cash register to the computer based order processing system; and
a means of interfacing restaurant accounting and inventory systems to the order processing system, wherein the order processing system accepts patron food and beverage orders, routes orders to food preparation and wait staff, presents electronic guest checks to patrons, accepts patron credit card payment of guest checks, tallies restaurant sales and menu items ordered to a data store for retrieval by external accounting and inventory management systems; and
one or more restaurant electronic menu, ordering and payment devices operable in a plurality of areas within and about the restaurant, the devices providing electronic food ordering and bill payment functions, the one or more devices distributed among and in use by restaurant patrons, the device comprising:
a housing having a slot for a printed paper receipt to be expelled through;
electronic computer based logic board secured within the housing;
an attention light secured to an outside surface of the housing and interfaced to the logic board;
a receipt printer secured within the housing, said printer for printing guest checks and credit card payment receipts;
a card swipe reader for reading a credit card for payment of the guest check, the card swipe reader secured to the housing and interfaced to the electronic logic board;
a means of data communication between the device and a restaurant order and payment system; and
a menu driven backlit graphic display screen secured to top surface of the housing, the graphic display screen having touch input capabilities, wherein patrons use screen touch input to select menus for display, to page forward and backward through menus, to order food and beverage items from the restaurant menu, to specify food preparation options, for example ‘well done’ or ‘no onions’; to summon wait staff to the table; to receive an electronic guest check; wherein the display screen displays advertisements and other announcements.

2. The restaurant electronic menu, ordering and payment device of claim 1, wherein the means of data communication comprises a wireless network over which the one or more order and payment devices are in cooperative communication with the computer based order, routing and payment processing system.

3. The restaurant electronic menu, ordering and payment device of claim 1, wherein the means of data communication comprises a physical data link over which the one or more order and payment devices are in cooperative communication with the computer based order, routing and payment processing system.

4. A method of providing electronic food and beverage ordering and payment to patrons of a restaurant, the method comprising:
providing a computer based order processing system having one or more display stations viewable and accessible by restaurant cook and wait staff;
providing one or more electronic menu, ordering and payment devices, the devices distributed among patrons of the restaurant, the device having a graphic display with touch input capabilities, the device having a credit/debit card reader, the device having a printer for printing receipts, the device having an attention light secured to the device, the device in cooperative data communication with the computer based order processing system;
assigning electronic menu, ordering and payment devices to patrons as they enter restaurant;
browsing restaurant specials and food beverage menu on the device by patron;
selecting one or more menu items to order on the touch input screen of the device;
if alcoholic beverage selected, then prompting patron to confirm legal age;
transmitting patron order to order processing system; and
routing the order to display stations of the computer based order processing system so that the wait staff may prepare and assemble the order and deliver to the restaurant patrons.

5. The method of claim 4, wherein after the transmitting patron order step, the method further comprises:
displaying touch actuated menu of payment options to patron on graphic display screen, wherein payment options comprise credit/debit card and pay at cash register;
if patron selects pay by credit/debit card, then:
prompting patron to swipe credit card in card reader;
transmit credit card information to order processing system;
if payment accepted, then closing out patron guest check and printing receipt; and
if payment declined, then warning user payment declined, pay at register;
if patron selected pay at cash register, then:
print guest check; and
prompt patron to pay at register; and
returning electronic menu, ordering and payment device to restaurant staff before patron leaves restaurant.

6. The method of claim 5, wherein before the returning step, the method further comprises:
if patron selects to check order status, then:
querying the order processing system on status of orders placed through the electronic menu ordering and payment device; and
displaying order status on graphic display screen.

7. The method of claim 4, wherein before the returning step, the method further comprises:
if patron selects summon wait staff to table, then:
transmitting a wait staff needed message to order processing system; and
activating the attention light on the electronic menu, ordering and payment device.
